(19) United States
(12) Patent Application Publication
(10) Pub. No.: US 2021/0370224 A1
(43) Pub. Date: Dec. 2, 2021

(54) METHOD TO SEPARATE A GAS MIXTURE CONTAINING CARBON DIOXIDE USING TWO STAGE ADSORPTION PROCESS

(71) Applicants: Lea Rose Vecchiarelli, Colts Neck, NJ (US); Apurva Maheshwary, Edison, NJ (US); John Robert Ambriano, Hockessin, DE (US); James Joseph Flaherty, Hampton, NJ (US)

(72) Inventors: Lea Rose Vecchiarelli, Colts Neck, NJ (US); Apurva Maheshwary, Edison, NJ (US); John Robert Ambriano, Hockessin, DE (US); James Joseph Flaherty, Hampton, NJ (US)

(21) Appl. No.: 16/886,182

(22) Filed: May 28, 2020

(51) Int. Cl. B01D 53/047; B01D 53/053

(52) U.S. Cl. CPC B01D 53/0476; B01D 2257/504; B01D 2258/0283; B01D 53/053

(57) ABSTRACT

The present invention provides for a method utilizing two sets of adsorber beds wherein one operates as a pressure swing adsorption system and the other operates as a vacuum swing adsorption system to separate carbon dioxide from a mixture of gases obtaining a higher purity of carbon dioxide thus separated than any prior art process.

### FIELD OF THE INVENTION

The present invention relates to a process for separating carbon dioxide gas from a mixture of gases, particularly nitrogen and oxygen gas, using cyclic two stage adsorption process. The process may utilize up to two sets of adsorption bed(s) to allow purified gas from one set to get further purified in a second step. Each of these adsorption bed sets may be regenerated by either conventional pressure swing adsorption or vacuum swing adsorption to separate and further purify carbon dioxide. These adsorption bed(s) can be of any geometric configuration including vertical and horizontal.

### BACKGROUND OF THE INVENTION

Cyclic adsorption processes are frequently used to separate the components of a gas mixture, typically using one or more adsorber vessels that are packed with a particulate adsorbent material which adsorbs at least one gaseous component of the gas mixture more strongly than it adsorbs at least one other component of the mixture. The adsorption process comprises repeatedly performing a series of steps, the specific steps of the sequence depending upon the cyclic adsorption process being carried out. In any cyclic adsorption process, the adsorber bed has a finite capacity to capture a given gaseous component and therefore the adsorbent requires periodic regeneration to restore its adsorption capacity. The procedure followed for regenerating the adsorbent varies according to the process. In most cases however, the regeneration is done by reduction in pressure or elevation of temperature or changing the concentration of the adsorbed species. Normally the adsorption step is carried out at a pressure higher than the regeneration step.

The regeneration process may also include a purge step during which a gas stream that is depleted in the component to be desorbed is passed counter-currently through the adsorber bed thereby reducing the partial pressure of adsorbed component, which in turn causes additional adsorbed component to be desorbed from the adsorbent. The non-adsorbed gas product may be used to purge the adsorber beds since this gas is usually quite depleted in the adsorbed component of the feed gas mixture. It often requires a considerable quantity of purged gas to adequately regenerate the adsorbent. For example, it is not unusual to use half of the non-adsorbed product gas produced during the previous production step to restore the adsorbent to the desired extent.

It is important to remove carbon dioxide from flue gases from industrial processes to reduce the amount getting emitted into the air. When carbon dioxide is emitted to the atmosphere there are numerous environmental concerns. Carbon dioxide is a greenhouse gas, and contribute to the warming of the earth, as well as ocean acidification, and human health concerns. Many processes using adsorption have been proposed in the past to extract carbon dioxide from flue gas, but it has been difficult to commercialize these inventions due to economic constraints. If we can find a use for carbon dioxide to be used in other industrial processes, then it would be a viable economic investment. In this process we wanted to achieve the purification of carbon dioxide so that it can be used as a raw material in other industrial processes.

### SUMMARY OF THE INVENTION

The present invention provides a method to integrate two sets of adsorption beds, used in a configuration that allows two stage separation and purification of gases. The process may also use a buffer vessel to store product gas from one stage to before it enters a second stage as a feed. As such, the process can be used to separate any gas mixture and specifically but not limited to carbon dioxide from combustion flue gases.

The flue gas mixture will be compressed using blower C1. It will then pass on to adsorber tank A1 through the switching valve 1. In the adsorber tank A1 the carbon dioxide is preferentially adsorbed on a suitable desiccant. Un-adsorbed gaseous components from the feed gas pass through valve 5 to vent and a portion of these un-adsorbed gaseous components goes through valve 6 into adsorber tank A2 as a purge gas. The adsorber tank A2 gets regenerated by depressurizing through valve 4. The depressurized gas from adsorber tank A2 has higher concentration of carbon dioxide than the flue gas. This concentrated mixture of gas is then collected in the buffer tank D1. The gas mixture in buffer tank D1 is the source of feed to the next stage of the process. Once the adsorber tank A2 has been fully regenerated it is switched as a feed bed with adsorber tank A1. The feed gas is then switched onto adsorber tank A2 through switching valve 3. In the adsorber tank A2 the carbon dioxide is preferentially adsorbed on a suitable desiccant. The un-adsorbed gaseous components from the feed gas get released from valve 7 and a potion of this gas goes through valve 6 into adsorber tank A1. The adsorber tank A1 gets regenerated by depressurizing through valve 2. The depressurized gas from adsorber tank A1 has higher concentration of carbon dioxide than the flue gas. This cycle of operation between adsorber tank A1 and A2 is repeated for continuous production of a concentrated mix of carbon dioxide.

The carbon dioxide rich feed gas from buffer tank D1 is fed to adsorber tank B1 through valve 8. In the adsorber tank B1 the carbon dioxide from the feed gas is preferentially adsorbed on a suitable desiccant. Un-adsorbed gaseous components in the adsorber tank B1 gets released from valve 12 to the vent and a portion of this gas goes through valve 13 into adsorber tank B2 as a purge gas. Most of the vent gas is vented as a waste through valve 16. As soon as the concentration of carbon dioxide exceeds a threshold amount this vent gas is recycled back to the compressor C1 through valve 15. The adsorber tank B2 gets regenerated by depressurizing through valve 11. The depressurized gas from adsorber tank B2 is a highly concentrated mix of carbon dioxide and is the final product of the process. Once the adsorber tank B2 has been fully regenerated it is switched as a feed bed with adsorber tank B1. The feed gas is then passed on to adsorber tank B2 through switching valve 10. In the adsorber tank B2 the carbon dioxide is preferentially adsorbed on a suitable desiccant. The un-adsorbed gaseous components from the feed gas get released from valve 14 and a portion of this gas goes through valve 13 into adsorber tank B1. Most of the vent gas is vented as a waste through valve 16. As soon as the concentration of carbon dioxide exceeds a threshold amount this vent gas is recycled back to the compressor C1 through valve 15. The adsorber tank B1 gets regenerated by depressurizing through valve 9.

While the stage 1 adsorber tanks A1 and A2 are regenerated by depressurizing them without any assistance, the stage two adsorber tank B1 and B2 are regenerated by depressurizing using a vacuum pump VP1. This cycle of operation between adsorber tank B1 and B2 is repeated for continuous production of the product carbon dioxide.

### BRIEF DESCRIPTION OF THE DRAWINGS

FIG. 1 is the process variation.

### DETAILED DESCRIPTION OF THE INVENTION

The present invention provides for a process of separating carbon dioxide from a gas mixture on large scale through a series of two sets of multiple adsorption beds wherein the gas mixture go through set 1 for partial separation of carbon dioxide and the resultant mixture passes through set 2 to further purify the product gas.

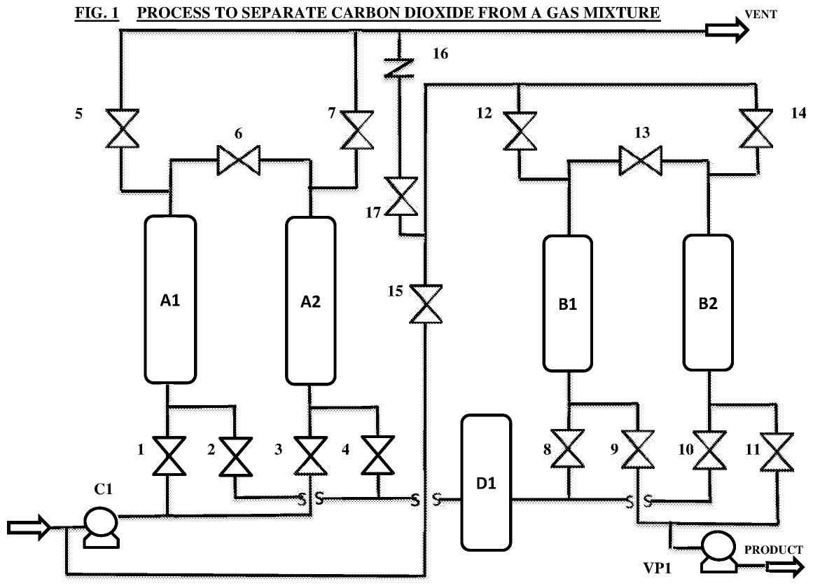

The present inventors anticipate a series of two sets of multiple adsorption beds as shown in FIG. 1. Set 1 comprises of a two bed system with adsorber beds A1 and A2. The process feed gas is compressed by compressor C1 before going to bed A1 through valve 1 or A2 through valve 3. The product gas is withdrawn from A1 using valve 2 or A2 using valve 4. The vent waste gas is withdrawn from A1 through valve 5 and from A2 through valve 7. Valve 6 allows for equalization of bed A1 and bed A2 during switchover from regeneration to production and vice versa. The product gas with higher concentration of carbon dioxide from valve 2 or valve 4 are sent to a buffer tank D1. Set 2 compromises of a two bed system with adsorber beds B1 and B2. The process feed gas from D1 is sent through valve 8 or valve 10 to beds B1 and B2. The product gas is withdrawn from B1 and B2 using valve 9 or valve 11. The vent waste gas is withdrawn from B1 through valve 12 and from B2 though valve 14. Valve 13 allows for equalization of bed B1 and bed B2 during switchover from regeneration to production and visa versa. The product gas with the required concentration of carbon dioxide is sent to VP1, vacuum pump. The vent waste gas with higher concentrations of carbon dioxide will be recycled through valve 15 to set 1 of the process, while at lower concentration will be vented through valve 17 and check valve 16 as waste.

Having thus described the invention, what we claim is:

1. An apparatus for separating carbon dioxide comprising: two sets of two adsorber beds (A1 & A2, B1 & B2 respectively), along with a buffer vessel (D1), vacuum pump (VP1), compressor (C1), product valves (2,4,9,11), feed valves (1,3,8,10), vent valves (5,7,12,14,15,17), equalization valves (6, 13), and check valve (16) as shown in FIG. 1, which allows separation of carbon dioxide gas from a mixture of gases such as flue gas to a concentration as high as 99% purity.

2. The apparatus of claim 1 comprising of two or more layers of adsorbent material in each of the adsorber beds.

3. The apparatus of claim 1 where set 2 of the process is regenerated under a vacuum level between −5 psig to −11 psig.

4. The apparatus of claim 1 where set 1 of the process receives feed gas between 3 psig and 15 psig.

5. The apparatus of claim 1 where set 1 of the process is regenerated under a pressure level between −1 psig to +2 psig.

6. The apparatus of claim 1 with a process cooler (HE1) to cool the feed gas at the compressor (C1) discharge.

7. The apparatus of claim 1 in which the feed gas is supplied under pressure or is compressed by compressor C1 to the desired pressure for set 1 of the process.
